(19) United States
(12) Patent Application Publication
(10) Pub. No.: US 2016/0249047 A1
(43) Pub. Date: Aug. 25, 2016

(54) IMAGE INSPECTION METHOD AND SOUND INSPECTION METHOD

(71) Applicant: K-WILL CORPORATION, Tokyo (JP)

(72) Inventor: Takahiro Hamada, Tokyo (JP)

(73) Assignee: K-WILL CORPORATION, Tokyo (JP)

(21) Appl. No.: 15/031,200

(22) PCT Filed: Oct. 23, 2013
(86) PCT No.: PCT/JP2013/078660

§ 371 Date: Apr. 21, 2016

(51) Int. Cl. H04N 17/00; G10L 25/60; H04N 21/44; H04N 21/234; H04N 21/233; H04N 21/439; G10L 25/21; G10L 25/57

(52) U.S. Cl. CPC H04N 17/004; G10L 25/21; G10L 25/60; G10L 25/57; H04N 21/23418; H04N 21/233; H04N 21/4394; H04N 21/44008; H04N 2017/006

(57) ABSTRACT

An image inspection method may include sampling a continuous digital image signal by dividing the signal by less than or equal to 20 msec; extracting a high-frequency component from the sampled signal; and detecting an error occurred in an image on the basis of the extracted high-frequency component.

### TECHNICAL FIELD

The present invention relates to an image inspection method and a sound inspection method capable of detecting an error in an image and sound included in a digital image and sound signal.

### BACKGROUND ART

Nowadays infrastructure, such as communication lines, and the like is improved, and thus digital image and sound signals have come to be transmitted from overseas, and it has become possible to domestically view overseas content easily. However, there are sometimes differences in the communication systems between domestic communication facilities and oversea communication facilities. Accordingly, it is difficult to completely prevent noise from being mixed in the signals at the time of conversion of the digital image and sound signals. When such noise is mixed in an image signal, an error, such as an image disorder, block noise or the like sometimes occurs. Also, when noise is mixed in a sound signal, the noise is sometimes recognized as an error, such as a “puff” sound (Audio Pop Noise), or the like. An audience might have an uncomfortable feeling by the occurrence of such an error, and thus a content inspection, in which an examiner actually views the content in advance, is carried out. However, there is a problem in that the content inspection requires long-time viewing using human eyes and ears, and thus the inspection result greatly varies in accordance with the physical condition and the individual difference. Also, the facility for the inspection becomes a big burden. Accordingly, there is a demand for a machine inspection in place of a human being.

Concerning this, Patent Document 1 discloses a technique in which pixels are differentiated for each predetermined rectangular block in order to mechanically detect block noise.

### CITATION LIST

### Patent Literature

PTL 1: Japanese Unexamined Patent Application Publication No. 2001-119695

PTL 2: Japanese Unexamined Patent Application Publication No. 2013-81078

### SUMMARY OF INVENTION

### Technical Problem

However, Patent Documents 1 and 2 are applied only to the image signals that have been subjected to compression and decompression processing, and a method for detecting an error due to all kinds of noise, such as a communication line problem, a VTR failure error, the other failures, or the like has not been achieved yet. In addition, techniques for inspecting a “puff” sound due to noise in sound signals, or the like with high precision have not been realized.

It is an object of the present invention to provide an image inspection method for detecting an image disorder caused by noise that occurs due to various causes in the digital image signal. Also, it is another object of the present invention to provide a sound inspection method for detecting a sound error caused by noise that occurs due to various causes in the digital sound signal.

### Solution to Problem

According to a first embodiment of the present disclosure, there is provided an image inspection method including: sampling a continuous digital image signal by dividing the signal by less than or equal to 20 msec; extracting a high-frequency component from the sampled signal; and detecting an error occurred in an image on the basis of the extracted high-frequency component.

With the present invention, it is possible to sample a continuous digital image signal by dividing the signal by less than or equal to 20 msec, which is a very short time period, to extract a high-frequency component from the sampled signal, and to detect an error occurred in an image with high precision in distinction from the actual content on the basis of the extracted high-frequency component.

It is preferable to divide one frame of the digital image signal into a plurality of areas, and to detect the error for each of the areas.

It is preferable that the error is an image disorder, and the extracted high-frequency component is an activity, which is the average of the variances of the digital image signal for each block.

It is preferable that when the activity (Vn(t)) is second-order differentiated with respect to time (t) to obtain d²Vn(t)/dt², if acceleration (d²Vn(t)/dt²)/Vn(t−1) is arranged in order of “positive, negative, and positive” or “negative, positive, and negative” along a time axis, a determination is made that an image disorder has occurred.

It is preferable that when the error is block noise, and if pixel values in an inspection block of the image signal are subjected to orthogonal transformation, and the transformation coefficient satisfies a predetermined condition, a determination is made that block noise has occurred.

It is preferable that when the transformation coefficient satisfies the predetermined condition, a determination is made that a corner has occurred in content displayed by the image signal.

It is preferable that the corner is distinguished between a corner due to block noise and a corner due to the content from the number of corners and a deviation thereof.

According to a second embodiment of the present disclosure, there is provided a sound inspection method including: sampling a continuous digital sound signal by dividing the signal by less than or equal to 5 msec; extracting a high-frequency component from the sampled signal; and detecting an error occurred in a sound on the basis of the extracted high-frequency component.

With the present invention, it is possible to sample a continuous digital sound signal by dividing the signal by less than or equal to 5 msec, which is a very short time period; to extract a high-frequency component from the sampled signal; and to detect sound noise occurred in an image with high precision in distinction from the actual content on the basis of the extracted high-frequency component.

It is preferable that when the digital sound signal is recorded on a plurality of channels, the error is detected for each of the channels.

It is preferable that when sampling is performed at time t along the time axis, frequency conversion is performed on the sampled signal, and n power values Pₙ(t) and a total power value P(t) in a predetermined bandwidth are obtained, respectively,

[1] if the total power value P(t) is higher than a first threshold value, and

[2] if a value (P(t)/P(t−T)) produced by dividing the total power value P(t) by total power value P(t−T) at time (t−T) before that time, and a value (P(t)/P(t+T)) produced by dividing the total power value P(t) by total power value P(t+T) at time (t+T) after that time are individually higher than a second threshold value, and

[3] if values (Pₙ(t)/P(T)) produced by dividing the individual power values Pₙ(t) by the total power value P(T) are higher than a third threshold value, a determination is made that an error has occurred.

It is preferable that when three power values along the time axis are compared, a first power value Pₙ(t−T5) and a third power value Pₙ(t+T+T5) are higher than a fourth threshold value, and a string of second power values Pₙ(t), . . . , Pₙ(t+T) is lower than a fifth threshold value, a determination is made that sound skipping has occurred.

It is preferable that when three power values Pₙ(t) along the time axis are compared, a first power value Pₙ(t−T5) and a third power value Pₙ(t+T+T5) are lower than a sixth threshold value, and a string of second power values Pₙ(t), . . . , Pₙ(t+T) is higher than a seventh threshold value, a determination is made that noise has occurred.

### Advantageous Effect of Invention

With the present invention, it is possible to provide an image inspection method for detecting an image disorder caused by noise generated in a digital image signal due to various causes. Also, it is possible to provide a sound inspection method for detecting a sound error caused by noise generated in a digital sound signal due to various causes.

### BRIEF DESCRIPTION OF DRAWINGS

FIG. 1 is a block diagram of an image and sound inspection apparatus 10.

FIG. 2(a) is a diagram illustrating a frame to be targeted for detecting an image disorder. FIG. 2(b) is a diagram illustrating a divided area.

FIG. 3 is a diagram illustrating an example in which accelerations AC at time (t−2), (t−1), t, (t+1), and (t+2) are illustrated by arrows along the time axis.

FIG. 4(a) is a diagram illustrating a frame to be targeted for detecting an image block noise. FIG. 4 (b) is a diagram illustrating a relationship between inspection blocks and block noise.

FIG. 5 is an example of a frame for displaying content.

FIG. 6 is a diagram illustrating a state in which a digital sound is divided into parts of 1 msec along the time axis, and 48 pieces of the sound data are sampled.

FIG. 7 is a diagram illustrating a change in power Pₙ(t) using the time axis as the horizontal axis.

FIG. 8 is a diagram illustrating a change in power Pₙ(t) using the time axis as the horizontal axis.

### DESCRIPTION OF EMBODIMENTS

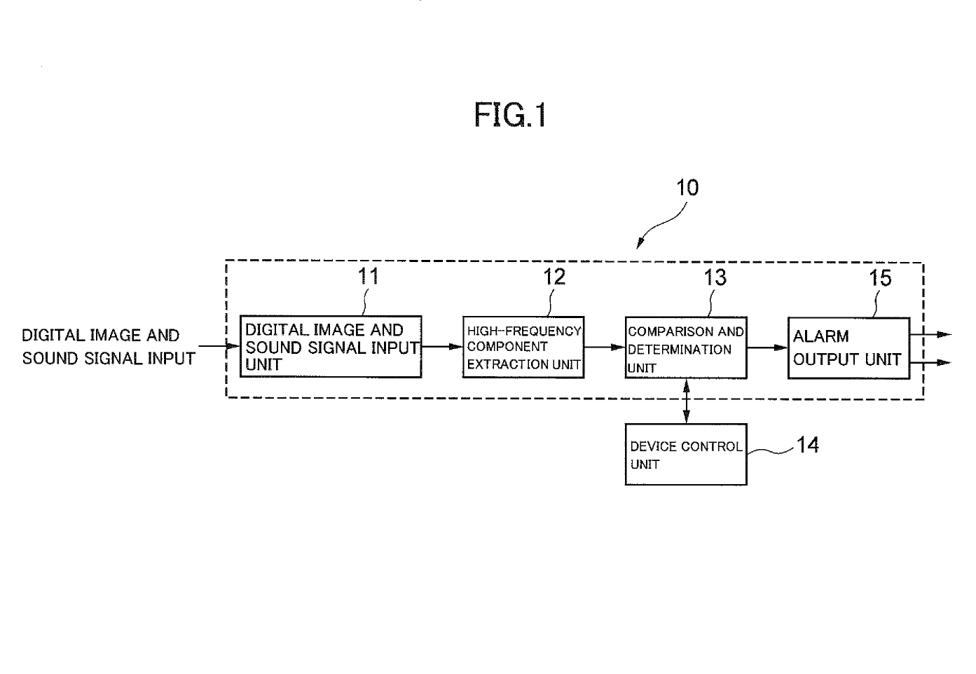

A description will be given of an image and sound inspection apparatus capable of achieving an image inspection method and a sound inspection method according to the present embodiment with reference to the drawings. FIG. 1 is a block diagram of an image and sound inspection apparatus 10. The image and sound inspection apparatus 10 includes an input unit 11 that receives input of a digital image and sound signal, an extraction unit 12 that extracts and calculates a high-frequency component from the input digital image and sound signal, a comparison and determination unit 13 that compares the high-frequency component with a threshold value on the basis of the extraction result of the extraction unit 12 and determines whether or not an error has occurred in the image or the sound, a control unit 14 that sets the threshold value or the like in the comparison and determination unit 13, and an output unit 15 that outputs an alarm in accordance with the determination result of the comparison and determination unit 13.

Detection of Image Disorder

An “image disorder” means a phenomenon in which a content image instantaneously disappears and then returns to normal between frames, or the content image is shifted. Here, a description will be given by taking, as an example, an image and sound signal by the BTAS-001B standard for the 1125/60 system HDTV (High-definition television) broadcasting that is standardized by, a general incorporated association, the Association of Radio Industries (ARIB). Such an image signal includes a luminance signal Y, and color-difference signals Pb and Pr.

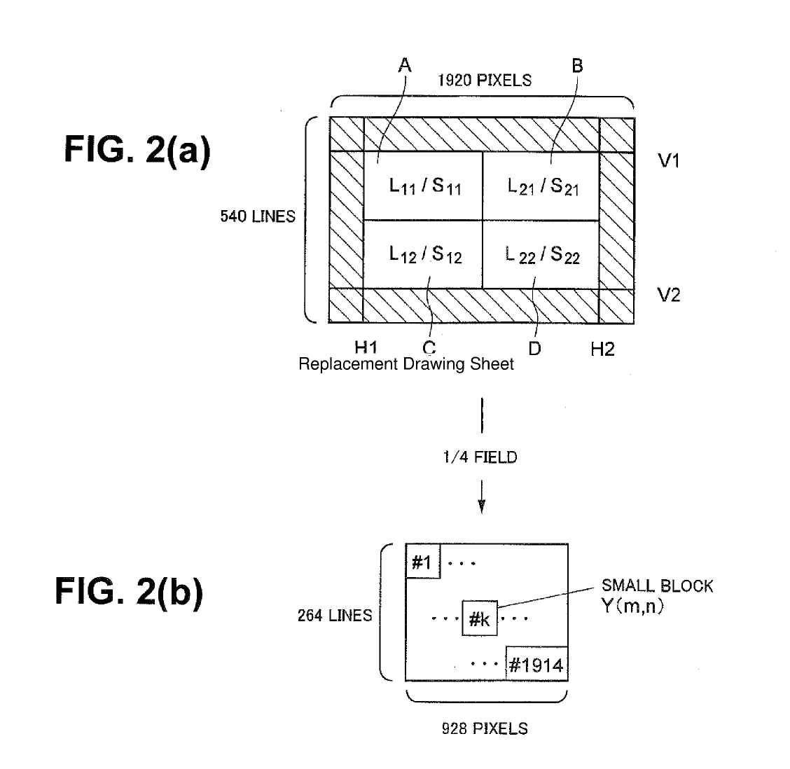

When an image and sound signal is input from the input unit 11 to the extraction unit 12, the extraction unit 12 divides within the range of lines V1 to V2 and pixels H1 to H2 in one frame into four fields (areas) A, B, C, and D as illustrated in FIG. 2(a), and performs calculation for each of the areas. Specifically, the extraction unit 12 calculates a video level (Video Level), and a video activity (Video Activity) for each field. Here, the Video Level is the average value of the pixel values included in the image frame, and is also referred to as a luminance signal level. Alternatively, a color-difference signal level may be used. Further, for the Video Activity, when a variance for each of small blocks included in an image is obtained, the average value of the pixels in the frame of the variance may be used, or the variance of the pixels of the image included in the image frame may be simply used.

More specifically, if it is assumed that there are 8 pixels from the frame ends to H1 and H2, respectively, and there are 8 pixels from the frame ends to V1 and V2, it is possible to set an inspection target frame to have H2=1864 pixels in the horizontal direction, and to have V2=536 lines in the vertical direction, and thus one field produced by dividing this by four has 928 pixels and 264 lines. Here, as illustrated in FIG. 2(b), small blocks having m lines and n pixels are formed in one field. That is to say, the luminance value of each pixel in a small block is represented by Y(m, n). Here, it is preferable to divide the luminance signal Y into small blocks having 16 pixels×8 lines. When the luminance signal Y is used, the number of small blocks in one field becomes 1914. In this regard, when color-difference signals Pb and Pr are used, it is preferable to divide into small blocks having 8 pixels×8 lines.

Further, the average of signals as a DC component and the variance as an AC component are obtained for each small block. That is to say, obtaining the variance as a video activity is extracting a high-frequency component. An expression (1) is an expression for obtaining the average A(k) of the luminance signal Y in a small block #k, and an expression (2) is an expression for obtaining the variance V(k) for the luminance signal Y in the small block #k. Thereby, the average A(k) and the variance V(k) are obtained in accordance with the number of blocks in the fields A to D, respectively (k=1 to 1914).

$$\begin{matrix}[ Expression 1 ] & \\ A ( k ) = \frac{1}{128} {\sum }_{n = 1}^{8} {\sum }_{m = 1}^{16} Y ( m , n ) & ( 1 ) \\ V ( k ) = \frac{1}{128} {\sum }_{n = 1}^{8} {\sum }_{m = 1}^{16} {\{ Y ( m , n ) - A ( k ) \}}^{2} & ( 2 )\end{matrix}$$

Further, the average A(k) and the variance V(k) obtained in accordance with the expressions (1) and (2) are averaged for each one field. An expression (3) is an expression for obtaining video averages FkA=L₁₁, L₂₁, L₁₂, and L₂₂ of each field, and an expression (4) is an expression for obtaining activity averages VkA=S₁₁, S₂₁, S₁₂, and S₂₂ of each field.

$$\begin{matrix}[ Expression 2 ] & \\ FkA = \frac{1}{1914} {\sum }_{k = 1}^{1914} A ( k ) & ( 3 ) \\ FkA = \frac{1}{1914} {\sum }_{k = 1}^{1914} V ( k ) & ( 4 )\end{matrix}$$

Here, if it is assumed that the video activity in the n-th block #n in one field at time t is Vn(t), attention is given to its change over time. On the basis of the time t, the video activities are calculated before that time, time (t−2) and (t−1), and after that time, time (t+1) and (t+2) as Vn(t−2), Vn(t−1), Vn(t+1), and Vn(t+2), respectively. Note that a time interval between (t−2), (t−1), t, (t+1), and (t+2) is less than or equal to 20 msec, and is assumed to be a unit time.

Here, when a first-order differential value is obtained at each time, the result becomes as follows.

dVn(t−1)/dt=Vn(t−1)−Vn(t−2) (5)

dVn(t)/dt=Vn(t)−Vn(t−1) (6)

dVn(t+1)/dt=Vn(t+1)−Vn(t) (7)

dVn(t+2)/dt=Vn(t+2)−Vn(t+1) (8)

Further, when a second-order differential value is obtained at each time, the result becomes as follows.

d²Vn(t)/dt²=dVn(t)/dt−dVn(t−1)/dt (9)

d²Vn(t+1)/dt²=dVn(t+1)/dt−dVn(t)/dt (10)

d²Vn(t+2)/dt²=dVn(t+2)/dt−dVn(t+1)/dt (11)

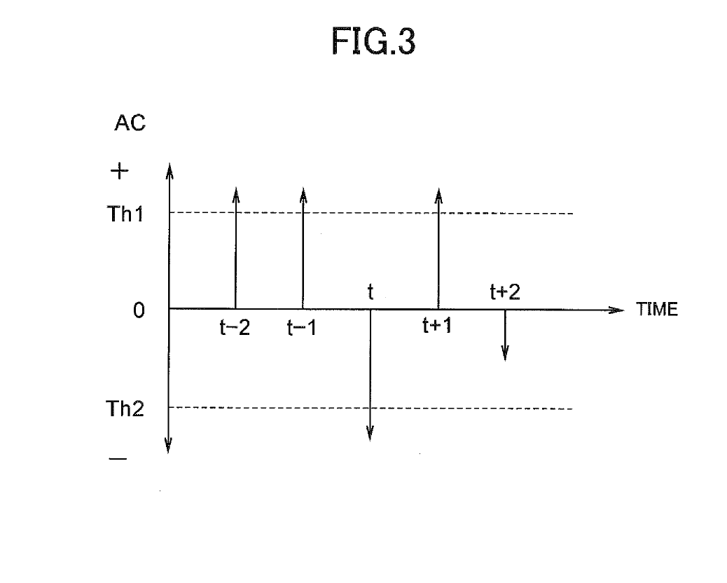

Here, (d²Vn(t)/dt²)/Vn(t−1) is defined as an acceleration AC of the content at time, and this is capable of having a positive or negative value. The acceleration AC is input from the extraction unit 12 to the comparison and determination unit 13. FIG. 3 illustrates an example in which the accelerations AC at time (t−2), (t−1), t, (t+1), and (t+2) are illustrated by arrows along the time axis. If an image disorder occurs, the acceleration AC of the content abnormally makes a movement different from the movement of an actual subject, and thus the acceleration AC changes significantly.

Specifically, the comparison and determination unit 13 compares three accelerations AC that are consecutive along the time axis. First, in FIG. 3, at time (t−2) and time (t−1), the accelerations AC are both positive values and higher than a threshold value Th1. On the other hand, at time (t), the acceleration AC is a negative value and lower than a threshold value Th2. In this case, the directions of the accelerations AC are the same between time (t−2) and time (t−1), and thus it is possible to determine that an image disorder has not occurred. On the other hand, the direction of the acceleration AC is negative at time t, and thus it is possible that an image disorder has occurred.

Next, at time (t+1), the direction of the acceleration AC returns to a positive value again, and the acceleration AC is higher than the threshold value Th1. Accordingly, the acceleration AC is greater than the threshold values between (t−1), t, and (t+1), and arranged in order of positive, negative, and positive. In this manner, if the acceleration AC changes greatly, it is possible to determine that an image disorder has occurred in a block in the area #n at time t. In the same manner, if the acceleration AC is higher than the threshold value, and is arranged in order of negative, positive, and negative, it is possible to determine that an image disorder has occurred.

Further, the direction of the acceleration AC has returned to a negative value again at time (t+2), but is not lower than the threshold value Th2. Accordingly, between time t, (t+1), and (t+2), the acceleration AC is arranged in order of negative, positive, and negative along the time axis, but is not greater than the threshold value. Accordingly, the image of the content is always within a normal range, and a determination is made that an image disorder has not occurred at time (t+1). In this regard, it is possible to change the values of the threshold values Th1 and Th2 to any values by the input from the device control unit 14. The above calculation and comparison are performed for all the small blocks.

If the comparison and determination unit 13 determines that an image disorder has occurred, the comparison and determination unit 13 inputs information indicating in which small block and in which field, an image disorder has occurred to the alarm output unit 15. The alarm output unit 15 displays an alarm on the monitor (not illustrated in the figure) on which the image and sound to be inspected is displayed on the basis of the input information. At this time, it is preferable to display an alarm by being superimposed on the image displayed on the monitor, for example. It is then possible to make the edges of the field in which the image disorder has detected shine in red.

(Detection of Image Block Noise)

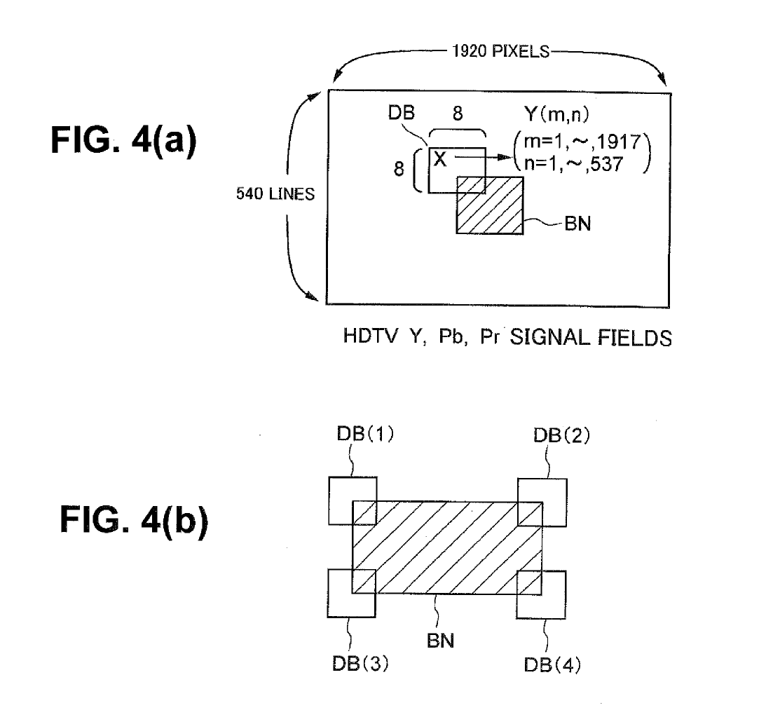

“Image block noise” means a phenomenon in which an image of content is converted into another image in a block state. Here, a description will be given by taking an HDTV image and sound signal as an example. As illustrated in FIG. 4, when the input digital image signal is sampled by dividing the signal by less than or equal to 20 msec, it is assumed that an inspection target frame is represented by 1920 pixels in the horizontal direction and 540 lines in the vertical direction. Here, the pixel values of the luminance signal of m pixels and n lines are represented by Y(m, n), and a pixel block (inspection block) of 8 pixels×8 lines is defined by this as the upper left end. The range of the inspection block is not limited to this. When an image and sound signal is input from the input unit 11, the extraction unit 12 performs two-dimensional discrete Fourier transform, which is an orthogonal transformation, on the pixel values in the inspection block. In this regard, for the orthogonal transformation, a discrete cosine transform, a wavelet transform, or the like is provided in addition to this, and it is possible to detect a corner of a block noise in the same manner using any one of the orthogonal transformations.

At this time, when 64 pixel values in an inspection block are represented by Y(0, 0) . . . , and Y(7, 7), and the Fourier transform coefficients are represented by F(u, v)=F(0, 0) . . . , and F(7, 7), a relationship of an expression (12) holds. By this Fourier transform, a high-frequency component is extracted.

$$\begin{matrix}[ Expression 3 ] & \\ F ( u , v ) = \frac{1}{8} {\sum }_{m = 0}^{7} {\sum }_{n = 0}^{7} Y ( m , n ) exp \{ - j2π ( um + vn ) / 8 \} & ( 12 )\end{matrix}$$

As a result of the Fourier transform performed by the extraction unit 12, if the Fourier transform coefficients satisfy any one of the following conditions 1 to 4, the comparison and determination unit 13 determines that the inspection block DB exists at any one of the four corners of the block noise BN illustrated in FIG. 4(a). Specifically, the conditions are as follows.

[1] If the condition 1 holds, this indicates that the pixels Y(6, 6), Y(7, 6), Y(6, 7), and Y(7, 7) of the inspection block DB are located in the block noise, and the other pixels are located outside the block noise. Accordingly, this means that the inspection block DB(1) illustrated in FIG. 4(b) is located at the upper left of the block noise BN.

[2] If the condition 2 holds, this indicates that the pixels Y(0, 6), Y(1, 6), Y(0, 7), and Y(1, 7) of the inspection block DB are located in the block noise, and the other pixels are located outside the block noise. Accordingly, this means that the inspection block DB(2) illustrated in FIG. 4(b) is located at the upper right of the block noise BN.

[3] If the condition 3 holds, this indicates that the pixels Y(6, 0), Y(7, 0), Y(6, 1), and Y(7, 1) of the inspection block DB are located in the block noise, and the other pixels are located outside the block noise. Accordingly, this means that the inspection block DB(3) illustrated in FIG. 4(b) is located at the lower left of the block noise BN.

[4] If the condition 4 holds, this indicates that the pixels Y(0, 0), Y(1, 0), Y(0, 1), and Y(1, 1) of the inspection block DB are located in the block noise, and the other pixels are located outside the block noise. Accordingly, this means that the inspection block DB(4) illustrated in FIG. 4(b) is located at the lower right of the block noise BN.

Accordingly, as illustrated by an arrow in FIG. 4(a), by moving the inspection block DB along the entire frame, if a block noise occurs, it is possible to identify the position and the size of the block noise. The inspection target frame may be divided by four, for example, and whether or not a block noise has occurred may be detected for each area.

### [Expression 4]

Condition 1: |W₃₀−W₃₃|/8≧Th3 and |W₀₃−W₃₃|/8≧Th3

P1/P2≧(Th4)², provided that

P1=(⅓){W₃₃²+W₃₀²+W₀₃²}

(unconditionally

holds when P2=0)
P2=( 1/12){W₂₁²+W₄₁²+W₁₂²+W₂₂²+W₃₂²+W₄₂²+W₂₃²+W₄₃²+W₄₄²+W₂₄²+W₃₄²+W₄₄²}
   Condition 2: |W₃₀−W₃₃|/8≧Th3 and |W₀₃−W₃₃|/8≧Th3 and

P1/P2≧(Th4)² (P2=0 unconditional)

Condition 3: |W₃₀+W₃₃|/8≧Th3 and |W₀₃−W₃₃|/8≧Th3 and

P1/P2≧(Th4)² (P2=0 unconditional)

Condition 4: |W₃₀+W₃₃|/8≧Th3 and |W₀₃+W₃₃|/8≧Th3 and

P1/P2≧(Th4)² (P2=0 unconditional)

Note that W_{UV} is a square root of sum of squares (√(A²+B²)) of a real part (A) and an imaginary part (B) of F(u, v).

Incidentally, with only the above-described conditions, a window of a building as content, characters inserted into an image, or the like might be detected as block noise. Thus, it is necessary to distinguish block noise from a window and characters. This is performed by the comparison and determination unit 13 as follows.

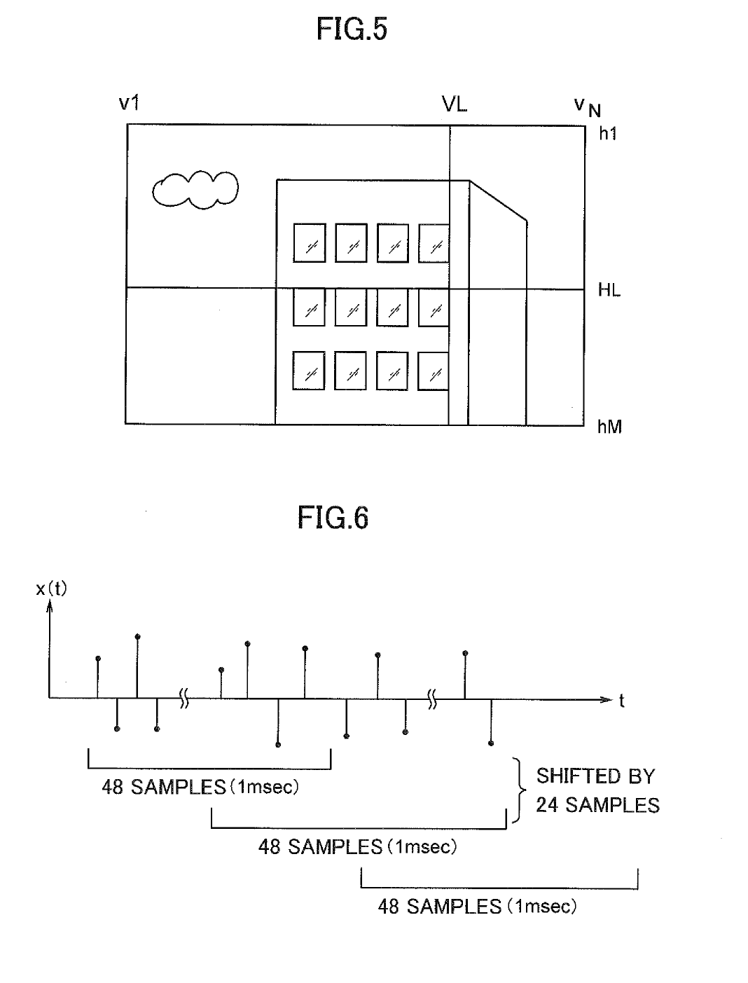

To give a more specific description, as illustrated in FIG. 5, if it is assumed that an inspection target area (or frame) includes N pixels (v₁ to v_{N})×M lines (h₁ to h_{M}), in the case of a window of content, characters, or the like, there is a high possibility that a corner occurs on the same vertical line or on the same horizontal line (corresponding to lines VL and HL in FIG. 5). Thus, it becomes possible to distinguish block noise from a window or characters by expressing the occurrence tendency of a corner as a standard deviation.

First, the total number of corners Nc in the inspection target area is equal to the total number of pixels where a corner has occurred, and is also equal to the total number of lines on which a corner has occurred, and thus is expressed by an expression (13). Further, it is assumed that the standard deviation (Dh)² of the corners that have occurred in the horizontal direction in the inspection target area is expressed by an expression (14), and the standard deviation (Dv)² of the corners that have occurred in the vertical direction is expressed by an expression (15).

$$\begin{matrix}[ Expression 5 ] & \\ Nc = {\sum }_{n = 1}^{N} vn = {\sum }_{m = 1}^{M} hm & ( 13 ) \\ {( Dh )}^{2} = \frac{1}{M} {\sum }_{m = 1}^{M} {( hm - \overline{h} )}^{2} , \overline{h} = \frac{1}{M} {\sum }_{m = 1}^{M} hm & ( 14 ) \\ {( Dv )}^{2} = \frac{1}{N} {\sum }_{n = 1}^{N} {( vn - \overline{v} )}^{2} , \overline{v} = \frac{1}{M} {\sum }_{n = 1}^{N} vn & ( 15 )\end{matrix}$$

Here, if the standard deviation of the corners is small, there is a strong tendency for the corners to be on the same vertical line or on the same horizontal line. Accordingly, when α=N×Dh×Dv is obtained in the inspection target area, if the value of α is relatively small, it is possible to estimate that there are many corners due to the content. Thus, if the comparison and determination unit 13 determines that a corner has occurred in the inspection target area, the comparison and determination unit 13 determines whether α is equal to or higher than a threshold value Th5. If α≧Th5, the comparison and determination unit 13 determines that block noise has occurred in the inspection target area. In this regard, it is possible to freely change the values of the threshold values Th3 to Th5 by the input from the device control unit 14.

If the comparison and determination unit 13 determines that image block noise has occurred, the comparison and determination unit 13 inputs the information including the position information indicating a corner, or the like into the alarm output unit 15. The alarm output unit 15 displays an alarm on the monitor (not illustrated in the figure) on which the image and sound to be inspected is displayed on the basis of the input information. At this time, it is desirable to display the positions of the corners of block noise superimposedly on the image displayed on the monitor.

(Detection of Sound Error)

One of sound errors detected by the present embodiment is a so-called “puff” sound that instantaneously occurs and disappears. The digital sound is input on four channels, for example, and thus an error for each of the channels is detected.

First, the extraction unit 12 divides the digital sound by 1 msec along the time axis as illustrated in FIG. 6, and samples 48 pieces of the audio data, for example. It is not necessary to have finer data than this, because the data exceeds a human audible range. Further, frequency conversion is carried out on each of the sound data by the discrete Fourier transform, which is an orthogonal transformation. Here, x(t) is a value of the sound level indicating the amplitude of sound at time t. Thereby, at time t, a high-frequency component fj(t) of the 23 pieces of sample data excluding a DC component is extracted as illustrated in an expression (16). In this regard, the sampling is performed by shifting for each 0.5 msec, for example as illustrated in FIG. 6.

$$\begin{matrix}[ Expression 6 ] & \\ {f}_{j} = {\sum }_{t = 0}^{47} x ( t ) {e}^{- \frac{2 π i}{48} j t} \\ ↓ \\ {f}_{0} , {f}_{1} , … {f}_{22} {f}_{23} & ( 16 )\end{matrix}$$

(f₀ direct current, and f₁ to f₂₃ alternating current)

(Detection of Puff Sound)

The comparison and determination unit 13 calculates the sum of squares of the real part and the imaginary part from the high-frequency component fj(t) at time t so as to obtain power. Accordingly, the power is calculated for all the samples, and this is assumed to be Pₙ(t) (Note that n=1 to 23).

It is understood that the power of a puff sound is uniform among the sample data. Assuming that the total power of the sample data m1 to m2 at time t is P(t), P(t) is expressed by an expression (17).

$$\begin{matrix}[ Expression 7 ] & \\ P ( t ) = {\sum }_{n = m 1}^{m 2} Pn ( t ) , 0 ≦ {m}_{1} , {m}_{2} ≦ 23 & ( 17 )\end{matrix}$$

The comparison and determination unit 13 determines that a puff sound has occurred when the following expressions (18) to (20) are satisfied. The condition of the expression (18) indicates that the sound signal is not zero, the expression (19) indicates that there is a relatively large change before and after a puff sound, and the expression (20) indicates that the power is relatively constant in the sampling time. In this regard, it is possible to change the values of the threshold values Th6 to Th8, T, m1, m2, n1, and n2 in any way by the input from the device control unit 14.

P(t)≧Th6 (18)

P(t)/P(t−T)≧Th7 and P(t)/P(t+T)≧Th7 (19)

Pₙ(t)/P(t)≧Th8 (Note that n is the sample data of any serial number n1 to n2 among the sample data #1 to #23) (20)

(Detection of Sound Skipping)

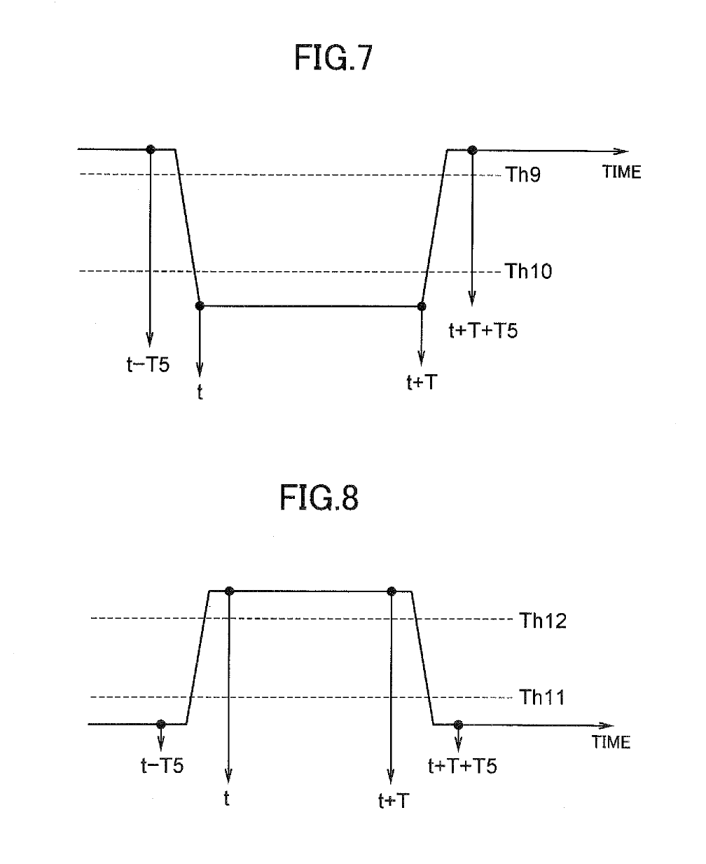

FIG. 7 is a diagram illustrating a change in power Pₙ(t) using the time axis as the horizontal axis. The comparison and determination unit 13 determines that sound skipping has occurred at time t when the following expressions (21) to (23) are satisfied for all the cases of n=1 to 23. This means that the sound power is lower than a threshold value Th10 for a time T from time t, but the power is higher than a threshold value Th9 before and after that. In this regard, it is possible to change the values of the threshold values Th9, Th10, T, and T5 in any way by the input from the device control unit 14.

Pₙ(t−T5)≧Th9 (21)

Pₙ(t),Pₙ(t+1), . . . Pₙ(t+T)≦Th10 (22)

Pₙ(t+T−T5)≧Th9 (23)

(Detection Noise Insertion)

FIG. 7 is a diagram illustrating a change in power Pₙ(t) using the time axis as the horizontal axis. The comparison and determination unit 13 determines that noise insertion has occurred at time t when the following expressions (24) to (26) are satisfied for all the cases of n=1 to 23. This means that the sound power is higher than a threshold value Th11 for a time T from time t, but the power is lower than a threshold value Th9 before and after that. In this regard, it is possible to change the values of the threshold values Th11, Th12, T, and T5 in any way by the input from the device control unit 14.

Pₙ(t−T5)≦Th11 (24)

Pₙ(t),Pₙ(t+1), . . . Pₙ(t+T)≧Th12 (25)

Pₙ(t+T−T5)≧Th11 (26)

If the comparison and determination unit 13 determines that a sound error has occurred, the comparison and determination unit 13 inputs an audio alarm signal to the alarm output unit 15. The alarm output unit 15 displays an alarm on the monitor (not illustrated in the figure) on which an image and sound to be inspected is displayed.

### INDUSTRIAL APPLICABILITY

With the present invention, it is possible to detect an image error and a sound error with high precision without relying on an examiner whose inspection precision is dependent on the examiner's physical condition and individual difference.

### REFERENCE SIGNS LIST

10 image and sound inspection apparatus
11 input unit
12 extraction unit
13 comparison and determination unit
14 control unit
15 alarm output unit

1. An image inspection method comprising:
sampling a continuous digital image signal by dividing the signal by less than or equal to 20 msec;
extracting a high-frequency component from the sampled signal; and
detecting an error occurred in an image on the basis of the extracted high-frequency component.

2. The image inspection method according to claim 1, further comprising dividing one frame of the digital image signal into a plurality of areas, and detecting the error for each of the areas.

3. The image inspection method according to claim 1,
wherein the error is an image disorder, and the extracted high-frequency component is an activity, the activity being an average of the variances of the digital image signal for each block.

4. The image inspection method according to claim 3,
wherein when the activity (Vn(t)) is second-order differentiated with respect to time (t) to obtain d²Vn(t)/dt², if acceleration (d²Vn(t)/dt²)/Vn(t−1) is arranged in order of “positive, negative, and positive” or “negative, positive, and negative” along a time axis, a determination is made that an image disorder has occurred.

5. The image inspection method according to claim 1,
wherein when the error is block noise, and if pixel values in an inspection block of the image signal is subjected to orthogonal transformation, and the transformation coefficient satisfies a predetermined condition, a determination is made that block noise has occurred.

6. The image inspection method according to claim 5,
wherein when the transformation coefficient satisfies the predetermined condition, a determination is made that a corner has occurred in content displayed by the image signal.

7. The image inspection method according to claim 6,
wherein the corner is distinguished between a corner due to block noise and a corner due to the content from the number of corners and a deviation thereof.

8. A sound inspection method comprising:
sampling a continuous digital sound signal by dividing the signal by less than or equal to 5 msec;
extracting a high-frequency component from the sampled signal; and
detecting an error occurred in a sound on the basis of the extracted high-frequency component.

9. The sound inspection method according to claim 8,
wherein when the digital sound signal is recorded on a plurality of channels, detecting the error is carried out for each of the channels.

10. The sound inspection method according to claim 8,
wherein when sampling is performed at time t along a time axis, frequency conversion is performed on the sampled signal, and n power values Pₙ(t) and a total power value P(t) in a predetermined bandwidth are obtained, respectively,
[1] if the total power value P(t) is higher than a first threshold value, and
[2] if a value (P(t)/P(t−T)) produced by dividing the total power value P(t) by total power value P(t−T) at time (t−T) before that time, and a value (P(t)/P(t+T)) produced by dividing the total power value P(t) by total power values P(t+T) at time (t+T) after that time are individually higher than a second threshold value, and
[3] if values (Pₙ(t)/P(T)) produced by dividing the individual power values Pₙ(t) by the total power value P(T) are higher than a third threshold value, a determination is made that an error has occurred.

11. The sound inspection method according to claim 8,
wherein when three power values along a time axis are compared, a first power value Pₙ(t−T5) and a third power value Pₙ(t+T+T5) are higher than a fourth threshold value, and a string of second power values Pₙ(t), . . . , Pₙ(t+T) is lower than a fifth threshold value, a determination is made that sound skipping has occurred.

12. The sound inspection method according to claim 8,
wherein when three power values Pₙ(t) along a time axis are compared, a first power value Pₙ(t−T5) and a third power value Pₙ(t+T+T5) are lower than a sixth threshold value, and a string of second power values Pₙ(t), . . . , Pₙ(t+T) is higher than a seventh threshold value, a determination is made that noise has occurred.

13. The image inspection method according to claim 2,
wherein the error is an image disorder, and the extracted high-frequency component is an activity, the activity being an average of the variances of the digital image signal for each block.

14. The image inspection method according to claim 2,
wherein when the error is block noise, and if pixel values in an inspection block of the image signal is subjected to orthogonal transformation, and the transformation coefficient satisfies a predetermined condition, a determination is made that block noise has occurred.

15. The sound inspection method according to claim 9,
wherein when sampling is performed at time t along a time axis, frequency conversion is performed on the sampled signal, and n power values Pₙ(t) and a total power value P(t) in a predetermined bandwidth are obtained, respectively,
[1] if the total power value P(t) is higher than a first threshold value, and
[2] if a value (P(t)/P(t−T)) produced by dividing the total power value P(t) by total power value P(t−T) at time (t−T) before that time, and a value (P(t)/P(t+T)) produced by dividing the total power value P(t) by total power values P(t+T) at time (t+T) after that time are individually higher than a second threshold value, and
[3] if values (Pₙ(t)/P(T)) produced by dividing the individual power values Pₙ(t) by the total power value P(T) are higher than a third threshold value, a determination is made that an error has occurred.

16. The sound inspection method according to claim 9,
wherein when three power values along a time axis are compared, a first power value Pₙ(t−T5) and a third power value Pₙ(t+T+T5) are higher than a fourth threshold value, and a string of second power values Pₙ(t), . . . , Pₙ(t+T) is lower than a fifth threshold value, a determination is made that sound skipping has occurred.

17. The sound inspection method according to claim 9,
wherein when three power values Pₙ(t) along a time axis are compared, a first power value Pₙ(t−T5) and a third power value Pₙ(t+T+T5) are lower than a sixth threshold value, and a string of second power values Pₙ(t), . . . , Pₙ(t+T) is higher than a seventh threshold value, a determination is made that noise has occurred.

18. The sound inspection method according to claim 10,
wherein when three power values along a time axis are compared, a first power value Pₙ(t−T5) and a third power value Pₙ(t+T+T5) are higher than a fourth threshold value, and a string of second power values Pₙ(t), . . . , Pₙ(t+T) is lower than a fifth threshold value, a determination is made that sound skipping has occurred.

19. The sound inspection method according to claim 10,
wherein when three power values Pₙ(t) along a time axis are compared, a first power value Pₙ(t−T5) and a third power value Pₙ(t+T+T5) are lower than a sixth threshold value, and a string of second power values Pₙ(t), . . . , Pₙ(t+T) is higher than a seventh threshold value, a determination is made that noise has occurred.
